(19) United States
(12) Patent Application Publication
(10) Pub. No.: US 2011/0141413 A1
(43) Pub. Date: Jun. 16, 2011

(54) LIQUID CRYSTAL DISPLAY PANEL

(75) Inventors: Takehiko Sakai, OSAKA (JP); Dai Chiba, Osaka (JP); Yoshiharu Kataoka, Osaka (JP); Tetsuo Fujita, Osaka (JP); Kazunori Morimoto, Osaka (JP)

(73) Assignee: SHARP KABUSHIKI KAISHA, Osaka-shi, Osaka (JP)

(21) Appl. No.: 13/058,896

(22) PCT Filed: Jun. 22, 2009
(86) PCT No.: PCT/JP2009/002836

§ 371 Date: Feb. 14, 2011

(30) Foreign Application Priority Data
Sep. 8, 2008 (JP) 2008-229753

(51) Int. Cl. G02F 1/1333

(52) U.S. Cl. 349/110

(57) ABSTRACT

A liquid crystal display panel (50a) including: an active matrix substrate (20a) including a plurality of light-reflecting lines (11), an insulating film (16) provided so as to cover the lines (11), and a plurality of pixel electrodes (19) provided in a matrix pattern on the insulating film (16); a counter substrate (30a) placed opposing the active matrix substrate (20a) and including a plurality of colored layers (22) provided in a matrix pattern so as to respectively overlap the pixel electrodes (19), and a black matrix (21a) provided between the colored layers (22); and a liquid crystal layer (40) provided between the active matrix substrate (20a) and the counter substrate (30a), wherein at least one of the black matrix (21a) and the lines (11) has a raised/recessed portion (C) whose surface is formed in a raised/recessed shape.

### TECHNICAL FIELD

The present invention relates to a liquid crystal display panel.

### BACKGROUND ART

A liquid crystal display panel includes, for example, an active matrix substrate, a counter substrate placed opposing the active matrix substrate, and a liquid crystal layer provided between the substrates.

The active matrix substrate includes, for example, a plurality of pixel electrodes provided in a matrix pattern, a plurality of gate lines provided so as to extend parallel to each other along one side of the pixel electrodes, and a plurality of source lines provided so as to extend parallel to each other along another side of the pixel electrodes in a direction perpendicular to the gate lines.

The counter substrate includes, for example, a plurality of colored layers provided in a matrix pattern so as to respectively overlap the pixel electrodes of the active matrix substrate, and a black matrix provided in a frame pattern including a lattice pattern inside the frame between the colored layers, i.e., so as to overlap the gate lines and the source lines of the active matrix substrate.

Here, the black matrix provided on the counter substrate has a light-blocking property and is configured so as to prevent light from the backlight provided on the back surface of the liquid crystal display panel from leaking through near the gate lines and the source lines of the active matrix substrate, for example.

For example, Patent Document 1 discloses a liquid crystal display device color filter including, on a glass substrate, at least a black matrix, colored pixels corresponding to the colored layers, and an orientation-regulating protrusion for regulating the orientation of the liquid crystal layer, wherein the orientation-regulating protrusion includes an orientation-regulating protrusion base and an insulating layer formed thereon with a transparent conductive film interposed therebetween. Patent Document 2 discloses a liquid crystal display device color filter similar to that of Patent Document 1, wherein the orientation-regulating protrusion includes a laminate of two or more colors formed by using materials of a plurality of colors forming the colored pixels, and an insulating layer formed thereon with a transparent conductive film interposed therebetween. Patent Documents 1 and 2 each state that it is possible with the liquid crystal display device color filter to reduce erroneous orientation of liquid crystal molecules and to prevent decrease in contrast even if light leakage occurs.

### CITATION LIST

### Patent Document

PATENT DOCUMENT 1: Japanese Published Patent Application No. 2008-51856
PATENT DOCUMENT 2: Japanese Published Patent Application No. 2008-52169

### SUMMARY OF THE INVENTION

### Technical Problem

Incidentally, in a liquid crystal display panel, along with the recent increase in the definition, display lines such as gate lines and source lines are designed with smaller line widths. Therefore, even if it is designed so that light leakage does not occur, in a semi-transmissive liquid crystal display panel using reflective electrodes as pixel electrodes, for example, light from the backlight which has entered the panel undergoes multiple reflections, resulting in light leakage, as will be described below.

FIG. 10 is a cross-sectional view showing a conventional semi-transmissive liquid crystal display panel 150a.

As shown in FIG. 10, the liquid crystal display panel 150a includes a TFT (Thin Film Transistor) substrate 120a provided as an active matrix substrate, a CF (Color Filter) substrate 130a provided as a counter substrate, and a liquid crystal layer 140 provided between the substrates 120a and 130a.

As shown in FIG. 10, the TFT substrate 120a includes a display line 114a such as a gate line or a source line provided on a glass substrate 110a, an organic insulating film 116 provided so as to cover the display line 114a, and a pixel electrode 119a provided in a matrix pattern on the organic insulating film 116. Here, as shown in FIG. 10, the pixel electrode 119a includes a transparent electrode 117, and a reflective electrode 118 layered thereon. In the TFT substrate 120a, the reflective electrode 118 defines the reflective region, and the transparent electrode 117 exposed through the reflective electrode 118 defines the transmissive region.

As shown in FIG. 10, the CF substrate 130a includes a black matrix 121a provided on a glass substrate 110b, and colored layers 122 provided between lattice strips of the black matrix 121a.

Here, in the liquid crystal display panel 150a, in a case where the display line 114a, the reflective electrode 118 and the black matrix 121a are formed by a metal material having a high reflectance such as an aluminum film, light L coming from the backlight may undergo multiple reflections at surfaces of the reflective electrode 118, the display line 114a and the black matrix 121a, as shown in FIG. 10, resulting in light leakage through near the black matrix 121a, thus lowering the display quality.

FIG. 11 is a cross-sectional view showing a conventional transmissive liquid crystal display panel 150b.

As shown in FIG. 11, the liquid crystal display panel 150b includes a TFT substrate 120b, a CF substrate 130b, and the liquid crystal layer 140 provided between the substrates 120b and 130b.

As shown in FIG. 11, the TFT substrate 120b includes a display line 114b such as a gate line or a source line provided on the glass substrate 110a, an inorganic insulating film 112 and an organic insulating film 115 provided in this order so as to cover the display line 114b, and a pixel electrode 119b provided in a matrix pattern on the organic insulating film 115.

As shown in FIG. 11, the CF substrate 130b includes a black matrix 121b provided on the glass substrate 110b, and colored layers 122 provided between lattice strips of the black matrix 121b.

Here, in the liquid crystal display panel 150b, particularly in a case where the black matrix 121b is formed by a metal material having a high reflectance such as an aluminum film so as to be wider than the display line 114b, light L coming from the backlight undergoes multiple reflections at surfaces of the black matrix 121b and the display line 114b, as shown in FIG. 11, and the orientation of liquid crystal molecules of the liquid crystal layer 40 is likely to be disturbed in step portions S where a step is formed on the substrate surface, resulting in light leakage through near the black matrix 121b, thus lowering the display quality.

The present invention has been made in view of the above, and has an object of reducing the occurrence of light leakage and suppressing the decrease in display quality.

### Solution to the Problem

In order to achieve the object, in the present invention, the surface of at least one of the black matrix and various lines has a raised/recessed portion formed in a raised/recessed shape.

Specifically, a liquid crystal display panel of the present invention is a liquid crystal display panel including: an active matrix substrate including a plurality of light-reflecting lines provided so as to extend parallel to each other, an insulating film provided so as to cover the lines, and a plurality of pixel electrodes provided in a matrix pattern on the insulating film; a counter substrate placed opposing the active matrix substrate, and including a plurality of colored layers provided in a matrix pattern so as to respectively overlap the pixel electrodes, and a black matrix provided between the colored layers; and a liquid crystal layer provided between the active matrix substrate and the counter substrate, wherein at least one of the black matrix and the lines has a raised/recessed portion whose surface is formed in a raised/recessed shape.

With such a configuration, where the surface of the black matrix has the raised/recessed portion, even if light of the backlight entering from the side of the active matrix substrate of the liquid crystal display panel is incident upon the surface of the black matrix on the counter substrate, it is scattered or absorbed by the raised/recessed portion formed on the surface of the black matrix. Where the surface of the lines has the raised/recessed portion, even if light of the backlight entering from the side of the active matrix substrate of the liquid crystal display panel is reflected by the surface of the black matrix on the counter substrate to be incident upon the surface of the lines on the active matrix substrate, it is scattered or absorbed by the raised/recessed portion formed on the surface of the lines. Moreover, where the surfaces of both the black matrix and the lines have the raised/recessed portion, even if light of the backlight entering from the side of the active matrix substrate of the liquid crystal display panel is incident upon the raised/recessed portion on the surface of the black matrix on the counter substrate, it is scattered or absorbed by the raised/recessed portion formed on the surface of the black matrix. Even if a portion of the scattered light is incident upon the surface of the lines on the active matrix substrate, it is scattered or absorbed by the raised/recessed portion formed on the surface of the lines. Thus, since light of the backlight entering from the side of the active matrix substrate of the liquid crystal display panel is scattered or absorbed by the raised/recessed portion formed on the surface of at least one of the black matrix and the lines, thereby reducing light leakage, it is possible to reduce the occurrence of light leakage and to reduce the decrease in display quality.

The raised/recessed portion may include a reflective film on the surface thereof for scattering light incident upon the surface.

With such a configuration, since the raised/recessed portion has a reflective film on the surface thereof, light of the backlight entering from the side of the active matrix substrate of the liquid crystal display panel is specifically scattered by the raised/recessed portion formed on the surface of at least one of the black matrix and the lines.

The raised/recessed portion may have a light-absorbing property for absorbing light incident upon the surface thereof.

With such a configuration, since the raised/recessed portion has a light-absorbing property by including black pigment therein, for example, light of the backlight entering from the side of the active matrix substrate of the liquid crystal display panel is specifically absorbed by the raised/recessed portion which is formed on the surface of at least one of the black matrix and the lines and has a relatively large surface area.

A raised portion of the raised/recessed portion may be formed in a hemispherical shape.

With such a configuration, since the raised portion of the raised/recessed portion is formed in a hemispherical shape, light of the backlight entering from the side of the active matrix substrate of the liquid crystal display panel is specifically scattered or absorbed by the spherical surface of the raised portion of the raised/recessed portion formed on the surface of at least one of the black matrix and the lines.

The pixel electrodes may each have a reflective electrode.

With such a configuration, since each pixel electrode has a reflective electrode, light of the backlight entering from the side of the active matrix substrate of the liquid crystal display panel is reflected by the surface (reverse surface) of the reflective electrode and then by the surface of the lines in the active matrix substrate to be then incident upon the counter substrate. Thus, advantages of the present invention are specifically realized.

The insulating film may be made of a resin.

With such a configuration, since the insulating film is made of a resin, the insulating film is likely to be formed to be as thick as about several μm. Thus, since the multiple reflections of light of the backlight entering from the side of the active matrix substrate of the liquid crystal display panel are likely to occur in the active matrix substrate, advantages of the present invention are effectively realized.

The pixel electrodes may each include a reflective region defined by the reflective electrode, and a transmissive region other than the reflective region.

With such a configuration, since each pixel electrode has the reflective region and the transmissive region, a semi-transmissive liquid crystal display panel is specifically configured.

### Advantages of the Invention

According to the present invention, since the surface of at least one of the black matrix and the lines has the raised/recessed portion formed in a raised/recessed shape, it is possible to reduce the occurrence of light leakage and to reduce the decrease in display quality.

### BRIEF DESCRIPTION OF THE DRAWINGS

FIG. 1 is a cross-sectional view showing a display section of a liquid crystal display panel 50a of Embodiment 1.

FIG. 2 is a cross-sectional view showing a TFT section of an active matrix substrate 20a of the liquid crystal display panel 50a.

FIG. 3 is a cross-sectional view schematically showing reflections of light L in the liquid crystal display panel 50a.

FIG. 4 is a cross-sectional view showing a liquid crystal display panel 50b of Embodiment 2.

FIG. 5 is a cross-sectional view showing a liquid crystal display panel 50c of Embodiment 3.

FIG. 6 is a cross-sectional view showing a liquid crystal display panel 50d of Embodiment 4.

FIG. 7 is a cross-sectional view showing a liquid crystal display panel 50e of Embodiment 5.

FIG. 8 is a cross-sectional view showing a liquid crystal display panel 50f of Embodiment 6.

FIG. 9 is a cross-sectional view showing a liquid crystal display panel 50g of Embodiment 7.

FIG. 10 is a cross-sectional view showing a conventional semi-transmissive liquid crystal display panel 150a.

FIG. 11 is a cross-sectional view showing a conventional transmissive liquid crystal display panel 150b.

### DESCRIPTION OF EMBODIMENTS

Embodiments of the present invention will now be described in detail with reference to the drawings. Note that the present invention is not limited to the following embodiments.

### Embodiment 1

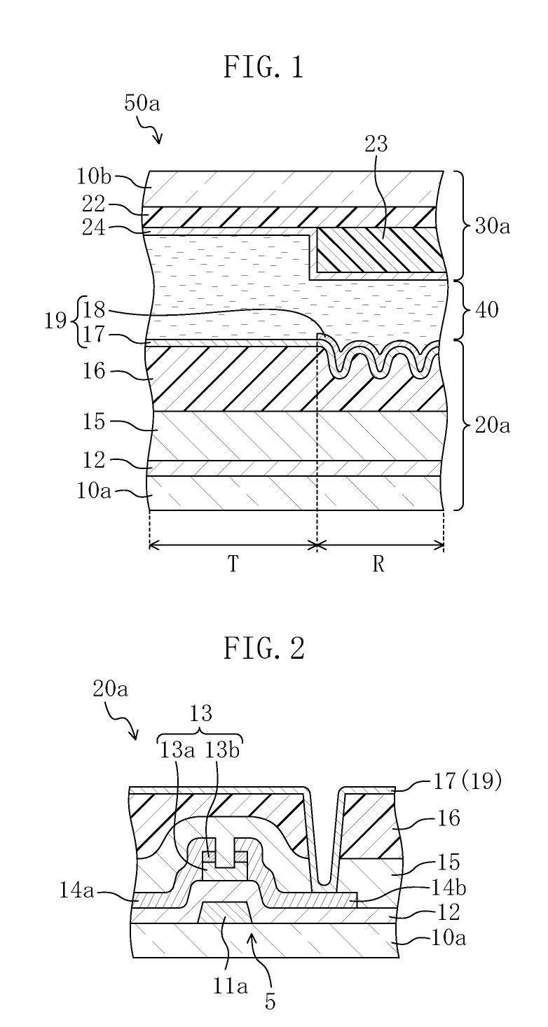

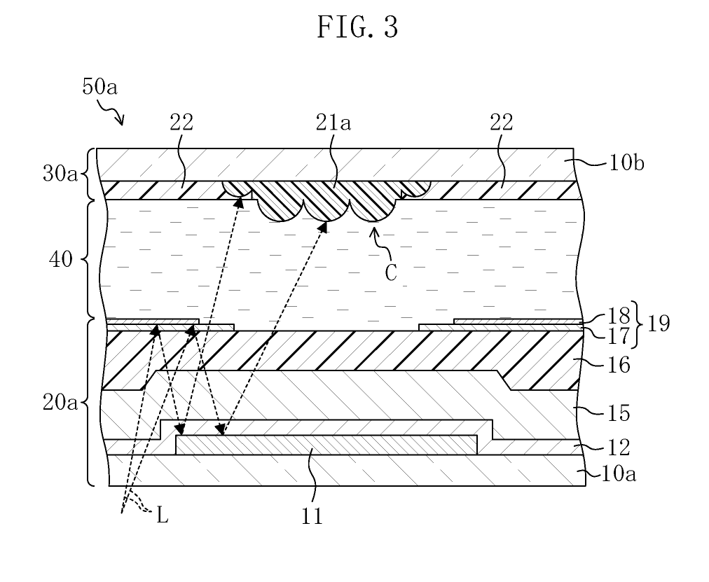

FIGS. 1-3 show Embodiment 1 of a liquid crystal display panel of the present invention. Specifically, FIG. 1 is a cross-sectional view showing a display section of a liquid crystal display panel 50a of the present embodiment, and FIG. 2 is a cross-sectional view showing a TFT section of an active matrix substrate 20a of the liquid crystal display panel 50a. FIG. 3 is a cross-sectional view schematically showing reflections of light L in the liquid crystal display panel 50a.

As shown in FIGS. 1 and 3, the liquid crystal display panel 50a includes: the active matrix substrate 20a and a counter substrate 30a placed so as to oppose each other; a liquid crystal layer 40 provided between the active matrix substrate 20a and the counter substrate 30a; and a sealing material (not shown) provided in a frame pattern for bonding the active matrix substrate 20a and the counter substrate 30a to each other and sealing the liquid crystal layer 40 between the active matrix substrate 20a and the counter substrate 30a.

As shown in FIGS. 1-3, the active matrix substrate 20a includes: a plurality of gate lines 11 provided so as to extend parallel to each other on an insulating substrate 10a such as a glass substrate; a gate insulating film 12 provided so as to cover the gate lines 11; a plurality of source lines 14a provided so as to extend parallel to each other in a direction perpendicular to the gate lines 11 on the gate insulating film 12; a plurality of TFTs 5 provided at the intersections between the gate lines 11 and the source lines 14a; a first interlayer insulating film 15 made of an inorganic insulating film and a resin-made second interlayer insulating film 16 made of an organic insulating film provided in this order so as to cover the source lines 14a and the TFTs 5; and a plurality of pixel electrodes 19 provided in a matrix pattern on the second interlayer insulating film 16 and connected to the TFTs 5.

As shown in FIG. 2, the TFT 5 includes a gate electrode 11a which is a portion of the gate line 11 protruding sideways, the gate insulating film 12 provided so as to cover the gate electrode 11a, a semiconductor layer 13 provided in an island-like pattern at a position overlapping the gate electrode 11a on the gate insulating film 12, and a source electrode (14a) and a drain electrode 14b provided so as to oppose each other over the semiconductor layer 13. Here, the source electrode (14a) is a portion of the source line 14a protruding sideways. As shown in FIG. 2, the drain electrode 14b is connected to a transparent electrode 17 which forms the pixel electrode 19 via a contact hole formed in the layered film of the first interlayer insulating film 15 and the second interlayer insulating film 16. Moreover, as shown in FIG. 2, the semiconductor layer 13 includes a lower intrinsic amorphous silicon layer 13a and an upper phosphorus-doped n⁺ amorphous silicon layer 13b, and a portion of the intrinsic amorphous silicon layer 13a exposed between the source electrode (14a) and the drain electrode 14b forms the channel region.

As shown in FIG. 1, the pixel electrode 19 is formed by the transparent electrode 17 provided on the second interlayer insulating film 16, and a reflective electrode 18 layered on the transparent electrode 17. Here, since the surface of the second interlayer insulating film 16 under the pixel electrode 19 is formed in a raised/recessed shape, as shown in FIG. 1, the surface of the reflective electrode 18 provided on the surface of the second interlayer insulating film 16 via the transparent electrode 17 is also formed in a raised/recessed shape.

In the active matrix substrate 20a and in the display section of the liquid crystal display panel 50a having the same, a reflective region R is defined by the reflective electrode 18 and a transmissive region T is defined by the transparent electrode 17 exposed through the reflective electrode 18, as shown in FIG. 1.

As shown in FIGS. 1 and 3, the counter substrate 30a includes: a black matrix 21a provided in a frame pattern including a lattice pattern inside the frame on an insulating substrate 10b such as a glass substrate, for example; a color filter 22 including red layers, green layers and blue layers provided between lattice strips of the black matrix 21a; a transparent layer 23 provided in the reflective region R of the color filter 22 so as to compensate for the optical path difference between the reflective region R and the transmissive region T; and a common electrode 24 provided so as to cover the black matrix 21a, the transmissive region T of the color filter 22 and the transparent layer 23 (the reflective region R). Note that FIG. 3 does not show the common electrode 24 on the black matrix 21a and the color filter 22.

As shown in FIG. 3, the black matrix 21a includes a raised/recessed portion C whose surface is formed in a raised/recessed shape. Here, the raised portion of the raised/recessed portion C is formed in a hemispherical shape. Since the black matrix 21a is formed by an organic insulating film with black pigment dispersed therein, for example, the raised/recessed portion C has a light-absorbing property. Thus, since the raised/recessed portion C having a light-absorbing property is provided on the surface of the black matrix 21a, even if light L of the backlight coming from the side of the active matrix substrate 20a of the liquid crystal display panel 50a is reflected by the surface of the reflective electrode 18 and then by the surface of the gate line 11 to be incident upon the surface of the black matrix 21a, as shown in FIG. 3, it is absorbed by the raised/recessed portion C on the surface of the black matrix 21a.

The liquid crystal layer 40 is formed by a nematic liquid crystal material, or the like, having an electrooptical property.

In the semi-transmissive liquid crystal display panel 50a having such a configuration, light coming from the side of the counter substrate 30a is reflected by the reflective electrode 18 in the reflective region R, whereas light from the backlight coming from the side of the active matrix substrate 20a is transmitted in the transmissive region T. In the liquid crystal display panel 50a, for each pixel, when a gate signal is sent from the gate line 11 to the gate electrode 11a to thereby turn ON the TFT 5, a source signal is sent from the source line 14a to the source electrode (14a), thus writing a predetermined charge to the pixel electrode 19, which is formed by the transparent electrode 17 and the reflective electrode 18, via the semiconductor layer 13 and the drain electrode 14b. In this process, a potential difference occurs between each pixel electrode 19 of the active matrix substrate 20a and the common electrode 24 of the counter substrate 30a in the liquid crystal display panel 50a, thus applying a predetermined voltage to the liquid crystal layer 40. In the liquid crystal display panel 50a, the orientation of the liquid crystal layer 40 is changed according to the level of the voltage applied to the liquid crystal layer 40, thereby adjusting the optical transmittance of the liquid crystal layer 40 and thus displaying an image.

Next, a method for manufacturing the liquid crystal display panel 50a of the present embodiment will be described by way of an example. The manufacturing method of the present embodiment includes an active matrix substrate production step, a counter substrate production step, and a substrate bond step.

<Active Matrix Substrate Production Step>

First, a titanium film, an aluminum film and a titanium film, etc., for example, are deposited in this order by a sputtering method across the entire substrate of the insulating substrate 10a such as a glass substrate, and are then patterned by photolithography, thereby forming the gate line 11 and the gate electrode 11a to a thickness of about 4000 Å.

Then, a silicon nitride film, or the like, for example, is deposited by a plasma CVD (Chemical Vapor Deposition) method across the entire substrate with the gate line 11 and the gate electrode 11a formed thereon, and the gate insulating film 12 is formed to a thickness of about 4000 Å.

Moreover, an intrinsic amorphous silicon film (thickness: about 2000 Å) and a phosphorus-doped n⁺ amorphous silicon film (thickness: about 500 Å), for example, are deposited successively by a plasma CVD method across the entire substrate with the gate insulating film 12 formed thereon, and are then patterned to form an island-like pattern on the gate electrode 11a by photolithography, thus forming a semiconductor formation layer in which an intrinsic amorphous silicon layer and an n⁺ amorphous silicon layer are layered together.

Then, an aluminum film and a titanium film, etc., for example, are deposited in this order by a sputtering method across the entire substrate with the semiconductor formation layer formed thereon, and are then patterned by photolithography to form the source line 14a, the source electrode (14a) and the drain electrode 14b to a thickness of about 2000 Å.

Then, the n⁺ amorphous silicon layer of the semiconductor formation layer is etched by using the source electrode (14a) and the drain electrode 14b as a mask, thereby patterning the channel region, and thus forming the semiconductor layer 13 and the TFT 5 having the same.

Moreover, a silicon nitride film, or the like, for example, is deposited by a plasma CVD method across the entire substrate with the TFT 5 formed thereon, thereby forming the first interlayer insulating film 15 to a thickness of about 4000 Å.

Then, a positive-type photosensitive resin, for example, is applied to a thickness of about 3 μm by a spin coat method across the entire substrate with the first interlayer insulating film 15 formed thereon. The applied photosensitive resin is exposed uniformly with relatively low luminous intensity via a first photomask including a plurality of circular light-blocking portions spaced apart from one another in a random pattern, and is then exposed uniformly with relatively high luminous intensity via a second photomask including openings formed at positions corresponding to the contact holes over the drain electrodes 14b, after which it is developed. Thus, portions of the photosensitive resin that have been exposed with high luminous intensity as described above are completely removed, about 40% of the thickness remains of those that have been exposed with low luminous intensity, and about 80% of the thickness remains of those that have not been exposed. Moreover, the substrate on which the photosensitive resin has been developed is heated to about 200° C. so as to thermally deform the photosensitive resin, thereby forming the second interlayer insulating film 16 in which the surface of the reflective region R is in a smooth raised/recessed shape. Then, the first interlayer insulating film 15 exposed through the second interlayer insulating film 16 is etched to thereby form contact hole.

Then, a transparent conductive film of an ITO (Indium Tin Oxide) film, or the like, is deposited on the second interlayer insulating film 16 across the entire substrate by a sputtering method, and is then patterned by photolithography, thereby forming the transparent electrode 17 to a thickness of about 1000 Å.

Moreover, a molybdenum film (thickness: about 750 Å) and an aluminum film (thickness: about 1000 Å) are deposited in this order by a sputtering method across the entire substrate with the transparent electrode 17 formed thereon, and are then patterned by photolithography to thereby form the reflective electrode 18, thus providing the pixel electrode 19 including the transparent electrode 17 and the reflective electrode 18.

Finally, a polyimide resin is applied by a printing method across the entire substrate with the pixel electrode 19 formed thereon, and then a rubbing process is performed, thereby forming an alignment film to a thickness of about 1000 Å.

The active matrix substrate 20a can be produced as described above.

<Counter Substrate Production Step>

First, a positive-type photosensitive resin including black pigment such as carbon particles dispersed therein, for example, is applied by a spin coat method across the entire substrate of the insulating substrate 10b such as a glass substrate. The applied photosensitive resin is exposed via a photomask as in the method for forming the second interlayer insulating film 16 described above, and then developed and heated, thereby forming the black matrix 21a having the raised/recessed portion C on the surface thereof to a thickness of about 2.0 μm.

Then, an acrylic photosensitive resin colored in red, green or blue, for example, is applied on the substrate with the black matrix 21a formed thereon, and the applied photosensitive resin is patterned by being exposed via a photomask and then developed, thereby forming a colored layer of a selected color (e.g., the red layer) to a thickness of about 2.0 μm. Moreover, similar steps are repeated for the other two colors to thereby form the colored layers of the other two colors (e.g., the green layer and the blue layer) to a thickness of about 2.0 μm, thus providing the color filter 22.

Moreover, an acrylic photosensitive resin is applied by a spin coat method on the substrate with the color filter 22 formed thereon, and the applied photosensitive resin is exposed via a photomask and then developed, thereby forming the transparent layer 23 to a thickness of about 2 μm in the reflective region R.

Then, an ITO film, for example, is deposited by a sputtering method across the entire substrate with the transparent layer 23 formed thereon, thereby forming the common electrode 24 to a thickness of about 1500 Å.

Finally, a polyimide resin is applied by a printing method across the entire substrate with the common electrode 24 formed thereon, and then a rubbing process is performed, thereby forming an alignment film to a thickness of about 1000 Å.

The counter substrate 30a can be produced as described above.

<Bond Step>

First, a frame pattern is drawn with a sealing material of a UV-curing-and-thermosetting-type resin, or the like, by using a dispenser, for example, on the counter substrate 30a produced through the counter substrate production step.

Then, a liquid crystal material is dropped onto a region inside the sealing material of the counter substrate 30a with the sealing material drawing.

Moreover, the counter substrate 30a onto which the liquid crystal material has been dropped and the active matrix substrate 20a produced through the active matrix substrate production step described above are bonded to each other under depressurized atmosphere, and then the bonded assembly is released to atmospheric pressure to thereby pressurize the front surface and the reverse surface of the assembly.

Finally, the sealing material sandwiched by the assembly is irradiated with UV light, and then the assembly is heated to thereby cure the sealing material.

The liquid crystal display device 50a can be produced as described above.

As described above, since the surface of the black matrix 21a of the liquid crystal display panel 50a of the present embodiment has the raised/recessed portion C formed in a raised/recessed shape, even if light L of the backlight entering from the side of the active matrix substrate 20a is reflected by the surface (reverse surface) of the reflective electrode 18 and then by the surface of the gate line 11 to be incident upon the surface of the black matrix 21a, it is absorbed by the raised/recessed portion C which is formed on the surface of the black matrix 21a, having a light-absorbing property and having a relatively large surface area. Thus, it is possible to reduce the amount of light L incident upon the surface of the black matrix 21a of the liquid crystal display panel 50a that reaches the surface of the gate line 11 and is reflected again by the surface, and it is therefore possible to reduce the occurrence of light leakage from the liquid crystal display panel 50a. Therefore, with the semi-transmissive liquid crystal display panel 50a, it is possible to reduce the occurrence of light leakage and to reduce the decrease in display quality.

### Embodiment 2

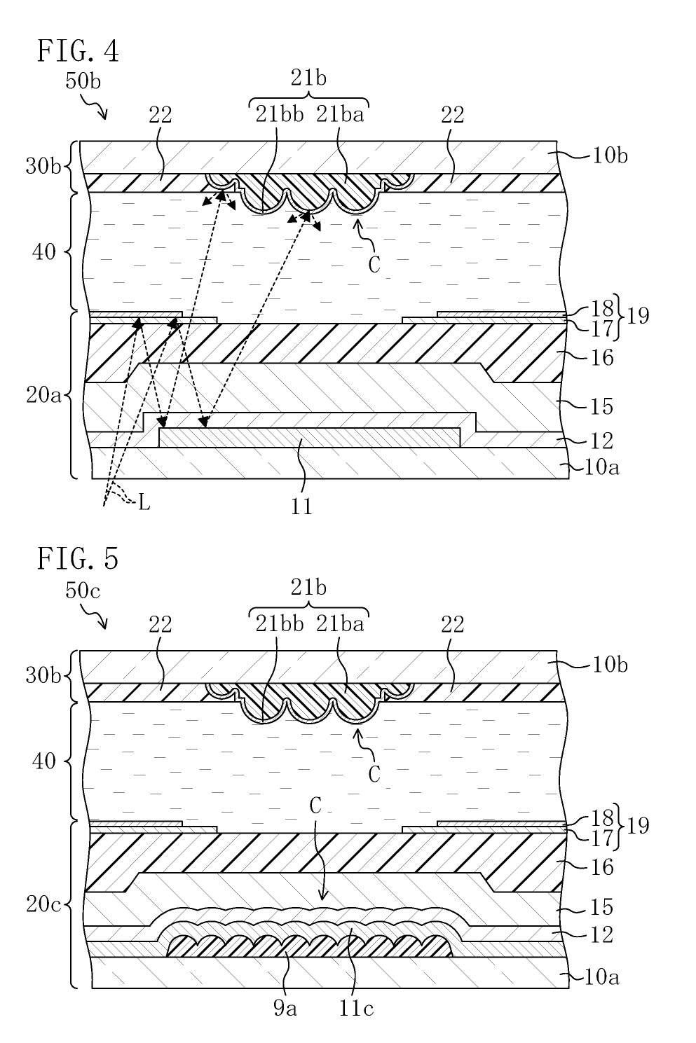

FIG. 4 is a cross-sectional view showing a liquid crystal display panel 50b of the present embodiment. Note that in the following embodiments, like elements to those of FIGS. 1-3 will be denoted by like reference numerals, and will not be described in detail.

While the black matrix 21a on the counter substrate 30a has a light-absorbing property in the liquid crystal display panel 50a of Embodiment 1, a black matrix 21b on the counter substrate 30b has a reflective film 21bb on the surface thereof in the liquid crystal display panel 50b of the present embodiment.

As shown in FIG. 4, the liquid crystal display panel 50b includes: the active matrix 20a of Embodiment 1; the counter substrate 30b placed opposing the active matrix 20a; the liquid crystal layer 40 provided between the active matrix substrate 20a and the counter substrate 30b; and a sealing material (not shown) provided in a frame pattern for bonding the active matrix substrate 20a and the counter substrate 30b with each other and sealing the liquid crystal layer 40 between the active matrix substrate 20a and the counter substrate 30b.

As shown in FIG. 4, the counter substrate 30b includes: the black matrix 21b provided in a frame pattern including a lattice pattern inside the frame on the insulating substrate 10b such as a glass substrate, for example; the color filter 22 including red layers, green layers and blue layers provided between lattice strips of the black matrix 21b; a transparent layer (23) provided in a reflective region (R) of the color filter 22 so as to compensate for the optical path difference between the reflective region (R) and the transmissive region (T); and a common electrode (24) provided so as to cover the black matrix 21b, the transmissive region T of the color filter 22 and the transparent layer (23, the reflective region R).

As shown in FIG. 4, the black matrix 21b includes a base layer 21ba on the insulating substrate 10b whose surface is formed in a raised/recessed shape, and the reflective film 21bb provided so as to cover the base layer 21ba for scattering reflected light reflected by the reflective electrode 18 on the active matrix substrate.

The counter substrate 30b can be produced through the counter substrate production step of Embodiment 1 except that the substrate is exposed, developed and heated using a positive-type photosensitive resin with no black pigment dispersed therein, instead of a positive-type photosensitive resin with black pigment dispersed therein, to thereby form the base layer 21ba whose surface is in a raised/recessed shape, and then an aluminum film (thickness: about 1000 Å) is deposited thereon by a sputtering method and patterned by photolithography to thereby form the reflective film 21bb.

Since the surface of the black matrix 21b of the liquid crystal display panel 50b of the present embodiment has the raised/recessed portion C formed in a raised/recessed shape, even if light L of the backlight entering from the side of the active matrix substrate 20a is reflected by the surface (reverse surface) of the reflective electrode 18 and then by the surface of the gate line 11 to be incident upon the surface of the black matrix 21b, it is scattered by the reflective film 21bb of the raised/recessed portion C formed on the surface of the black matrix 21b. Thus, it is possible to reduce the amount of light L incident upon the surface of the black matrix 21b of the liquid crystal display panel 50b that reaches the surface of the gate line 11 and is reflected again by the surface, and it is therefore possible to reduce the occurrence of light leakage from the liquid crystal display panel 50b. Therefore, with the semi-transmissive liquid crystal display panel 50b, it is possible to reduce the occurrence of light leakage and to reduce the decrease in display quality.

### Embodiment 3

FIG. 5 is a cross-sectional view showing a liquid crystal display panel 50c of the present embodiment.

While the raised/recessed portion C is provided on the surface of the black matrices 21a and 21b in the liquid crystal display panel 50a of Embodiment 1 and in the liquid crystal display panel 50b of Embodiment 2, the raised/recessed portion C is provided not only on the surface of the black matrix 21b but also on the surface of gate lines 11c in the liquid crystal display panel 50c of the present embodiment.

As shown in FIG. 5, the liquid crystal display panel 50c includes: an active matrix 20c; the counter substrate 30b of Embodiment 2 placed opposing the active matrix 20c the liquid crystal layer 40 provided between the active matrix substrate 20c and the counter substrate 30b; and a sealing material (not shown) provided in a frame pattern for bonding the active matrix substrate 20c and the counter substrate 30b with each other and sealing the liquid crystal layer 40 between the active matrix substrate 20c and the counter substrate 30b.

As shown in FIG. 5, the active matrix substrate 20c has a resin layer 9a whose surface is in a raised/recessed shape between the insulating substrate 10a and the gate lines 11c, and therefore the surface of the gate lines 11c has the raised/recessed portion C formed in a raised/recessed shape, and the configuration is otherwise substantially equal to that of the active matrix substrate 20a of Embodiment 1.

The active matrix substrate 20c can be produced through the active matrix substrate production step of Embodiment 1 except that the resin layer 9a whose surface is in a raised/recessed shape is formed, before the formation of the gate lines 11, in a similar manner to the method for forming the second interlayer insulating film 16, followed by the formation of the gate lines 11c.

Since the surfaces of both the black matrix 21b and the gate lines 11c of the liquid crystal display panel 50c of the present embodiment have the raised/recessed portion C formed in a raised/recessed shape, even if light of the backlight entering from the side of the active matrix substrate 20c is reflected by the surface (reverse surface) of the reflective electrode 18 to be incident upon the surface of the gate line 11c, it is scattered by the surface of the raised/recessed portion C of the gate line 11c. Even if a portion of the scattered light is incident upon the surface of the black matrix 21b, it is scattered by the reflective film 21bb of the raised/recessed portion C formed on the surface of the black matrix 21b. Thus, since light of the backlight entering from the side of the active matrix substrate 20c of the liquid crystal display panel 50c is scattered by the raised/recessed portion C of the surface of the gate lines 11c and the raised/recessed portion C of the surface of the black matrix 21b, it is possible to reduce the occurrence of light leakage from the liquid crystal display panel 50c. Therefore, with the semi-transmissive liquid crystal display panel 50c, it is possible to reduce the occurrence of light leakage and to reduce the decrease in display quality.

### Embodiment 4

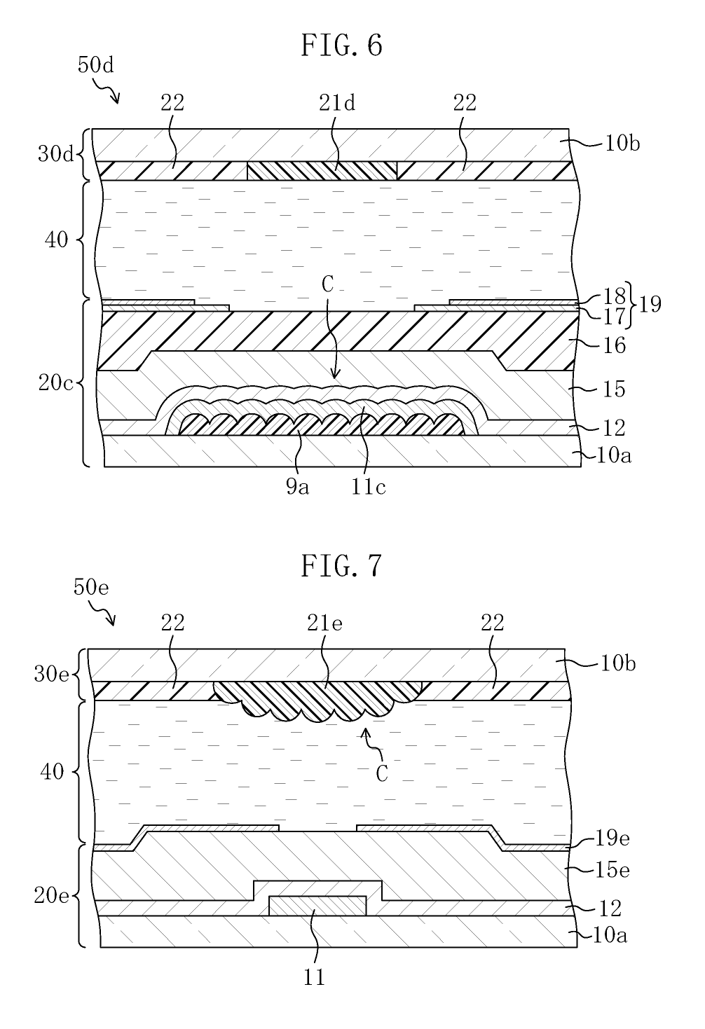

FIG. 6 is a cross-sectional view showing a liquid crystal display panel 50d of the present embodiment.

While the raised/recessed portion C is provided on the surface of the black matrices 21a and 21b in the liquid crystal display panel 50a of Embodiment 1 and in the liquid crystal display panel 50b of Embodiment 2, the raised/recessed portion C is provided on the surface of the gate lines 11c in the liquid crystal display panel 50d of the present embodiment.

As shown in FIG. 6, the liquid crystal display panel 50d includes: the active matrix 20c of Embodiment 3; a counter substrate 30d placed opposing the active matrix 20c; the liquid crystal layer 40 provided between the active matrix substrate 20c and the counter substrate 30d; and a sealing material (not shown) provided in a frame pattern for bonding the active matrix substrate 20c and the counter substrate 30d with each other and sealing the liquid crystal layer 40 between the active matrix substrate 20c and the counter substrate 30d.

As shown in FIG. 6, the counter substrate 30d includes: a black matrix 21d provided in a frame pattern including a lattice pattern inside the frame on the insulating substrate 10b such as a glass substrate, for example; the color filter 22 including red layers, green layers and blue layers provided between lattice strips of the black matrix 21d; a transparent layer (23) provided in a reflective region (R) of the color filter 22 so as to compensate for the optical path difference between the reflective region (R) and the transmissive region (T); and a common electrode (24) provided so as to cover the black matrix 21d, the transmissive region T of the color filter 22 and the transparent layer (23, the reflective region R). Here, the black matrix 21d is formed by an aluminum film, or the like, for example, and the surface thereof is formed to be flat.

The counter substrate 30d can be produced through the counter substrate production step of Embodiment 1 except that an aluminum film, for example, is deposited by a sputtering method and patterned by photolithography so as to form the black matrix 21d, instead of forming the black matrix 21a by applying a positive-type photosensitive resin with black pigment dispersed therein.

Since the surface of the gate lines 11c of the liquid crystal display panel 50d of the present embodiment has the raised/recessed portion C formed in a raised/recessed shape, even if light of the backlight entering from the side of the active matrix substrate 20c is reflected by the surface (reverse surface) of the reflective electrode 18 to be incident upon the surface of the gate line 11c, it is scattered by the surface of the raised/recessed portion C of the gate line 11c. Thus, since light of the backlight entering from the side of the active matrix substrate 20c of the liquid crystal display panel 50d is scattered by the raised/recessed portion C of the surface of the gate line 11c, it is possible to reduce the occurrence of light leakage from the liquid crystal display panel 50d. Therefore, with the semi-transmissive liquid crystal display panel 50d, it is possible to reduce the occurrence of light leakage and to reduce the decrease in display quality.

### Embodiment 5

FIG. 7 is a cross-sectional view showing a liquid crystal display panel 50e of the present embodiment.

While the semi-transmissive liquid crystal display panels 50a-50d are employed in the embodiments above, the present embodiment employs a transmissive liquid crystal display panel 50e.

As shown in FIG. 7, the liquid crystal display panel 50e includes: an active matrix substrate 20e and a counter substrate 30e placed opposing each other; the liquid crystal layer 40 provided between the active matrix substrate 20e and the counter substrate 30e; and a sealing material (not shown) provided in a frame pattern for bonding the active matrix substrate 20e and the counter substrate 30e with each other and sealing the liquid crystal layer 40 between the active matrix substrate 20e and the counter substrate 30e.

As shown in FIG. 7, the active matrix substrate 20e includes: a plurality of gate lines 11 provided so as to extend parallel to each other on the insulating substrate 10a such as a glass substrate; the gate insulating film 12 provided so as to cover the gate lines 11; a plurality of source lines (14a) provided so as to extend parallel to each other in a direction perpendicular to the gate lines 11 on the gate insulating film 12; a plurality of TFTs (5) provided at the intersections between the gate lines 11 and the source lines (14a); an interlayer insulating film 15e made of an inorganic insulating film, or the like, provided so as to cover the source lines (14a) and the TFTs (5); and a plurality of pixel electrodes 19e provided in a matrix pattern on the interlayer insulating film 15e and formed by transparent conductive films, or the like, connected to the TFTs (5).

The active matrix substrate 20e can be produced through the active matrix substrate production step of Embodiment 1 by omitting the formation of the second interlayer insulating film 16 and the reflective electrode 18.

As shown in FIG. 7, the counter substrate 30e includes: a black matrix 21e provided in a frame pattern including a lattice pattern inside the frame on the insulating substrate 10b such as a glass substrate, for example; the color filter 22 including red layers, green layers and blue layers provided between lattice strips of the black matrix 21e; and a common electrode (24) provided so as to cover the black matrix 21e and the color filter 22.

As shown in FIG. 7, the black matrix 21e includes the raised/recessed portion C whose surface is formed in a raised/recessed shape. Since the black matrix 21e is formed by an organic insulating film with black pigment dispersed therein, for example, the raised/recessed portion C has a light-absorbing property. Moreover, as shown in FIG. 7, the black matrix 21e is formed to be wider than the width of each gate line 11.

The counter substrate 30e can be produced through the counter substrate production step of Embodiment 1 by, for example, omitting the formation of the transparent layer 23.

Since the surface of the black matrix 21e of the liquid crystal display panel 50e of the present embodiment has the raised/recessed portion C formed in a raised/recessed shape, even if light of the backlight entering from the side of the active matrix substrate 20e is incident upon the surface of the black matrix 21e, it is absorbed by the surface of the raised/recessed portion C of the black matrix 21e. Thus, since light of the backlight entering from the side of the active matrix substrate 20e of the liquid crystal display panel 50e is absorbed by the raised/recessed portion C of the surface of the black matrix 21e, it is possible to reduce the occurrence of light leakage from the liquid crystal display panel 50e. Therefore, with the transmissive liquid crystal display panel 50e, it is possible to reduce the occurrence of light leakage and to reduce the decrease in display quality.

Note that while the present embodiment employs the configuration where the surface of the raised/recessed portion C of the black matrix 21e has a light-absorbing property, another configuration may be employed where the surface has a reflective film so that light from the backlight is scattered by the reflective film.

### Embodiment 6

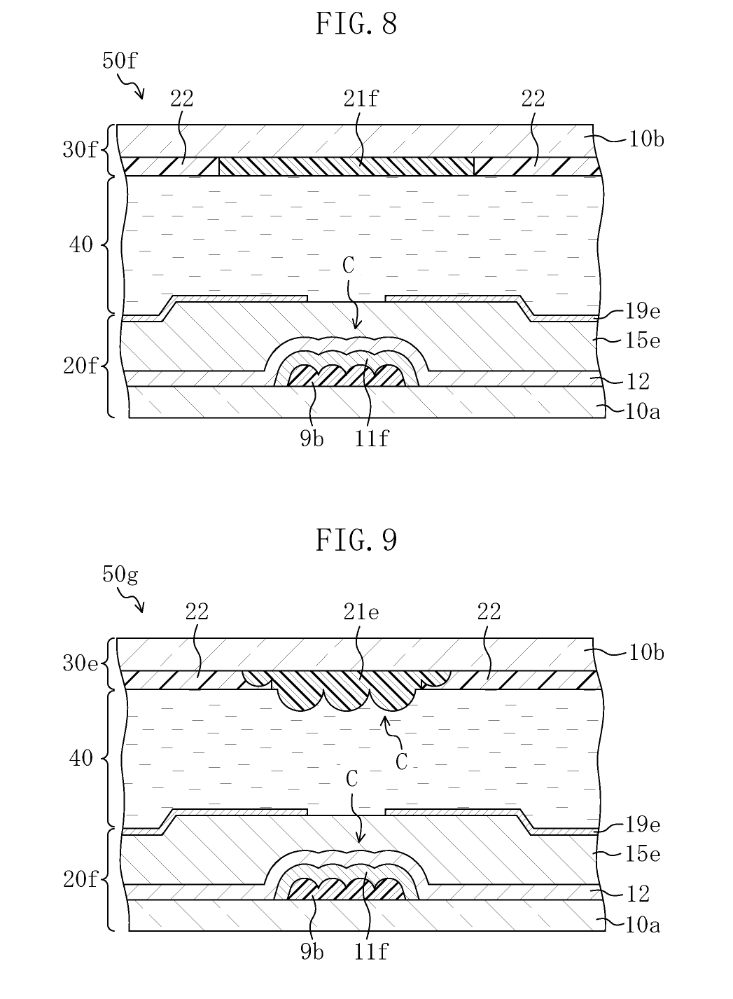

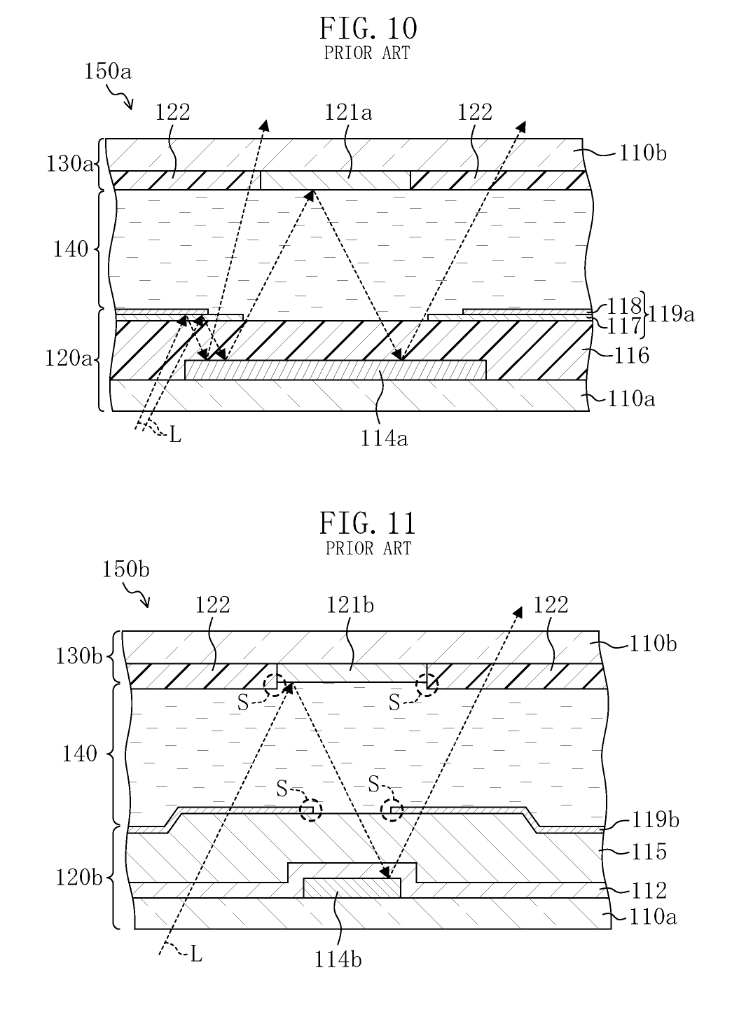

FIG. 8 is a cross-sectional view showing a liquid crystal display panel 50f of the present embodiment.

While the raised/recessed portion C is provided on the surface of the black matrix 21e in the transmissive liquid crystal display panel 50e of Embodiment 5, the raised/recessed portion C is provided on the surface of each gate line 11f in the transmissive liquid crystal display panel 50f of the present embodiment.

As shown in FIG. 8, the liquid crystal display panel 50f includes: an active matrix substrate 20f and a counter substrate 30f placed opposing each other; the liquid crystal layer 40 provided between the active matrix substrate 20f and the counter substrate 30f; and a sealing material (not shown) provided in a frame pattern for bonding the active matrix substrate 20f and the counter substrate 30f with each other and sealing the liquid crystal layer 40 between the active matrix substrate 20f and the counter substrate 30f.

As shown in FIG. 8, the active matrix substrate 20f includes: a plurality of gate lines 11f provided so as to extend parallel to each other on the insulating substrate 10a such as a glass substrate; the gate insulating film 12 provided so as to cover the gate lines 11f; a plurality of source lines (14a) provided so as to extend parallel to each other in a direction perpendicular to the gate lines 11f on the gate insulating film 12; a plurality of TFTs (5) provided at the intersections between the gate lines 11f and the source lines (14a); the interlayer insulating film 15e made of an inorganic insulating film, or the like, provided so as to cover the source lines (14a) and the TFTs (5); and a plurality of pixel electrodes 19e provided in a matrix pattern on the interlayer insulating film 15e and formed by transparent conductive films, or the like, connected to the TFTs (5). Here, since the resin layer 9b whose surface is in a raised/recessed shape is provided between the insulating substrate 10a and each gate line 11f, the raised/recessed portion C is provided where the surface of the gate line 11f is formed in a raised/recessed shape.

The active matrix substrate 20f can be produced through the active matrix substrate production step of Embodiment 1 by omitting the formation of the second interlayer insulating film 16 and the reflective electrode 18 while forming the resin layer 9b whose surface is in a raised/recessed shape before the formation of the gate lines 11f as in Embodiment 3.

As shown in FIG. 8, the counter substrate 30f includes: a black matrix 21f provided in a frame pattern including a lattice pattern inside the frame on the insulating substrate 10b such as a glass substrate, for example; the color filter 22 including red layers, green layers and blue layers provided between lattice strips of the black matrix 21f; and a common electrode (24) provided so as to cover the black matrix 21f and the color filter 22.

As shown in FIG. 8, the black matrix 21f is formed by an aluminum film, or the like, for example, and the surface thereof is formed to be flat. As shown in FIG. 8, the black matrix 21f is formed to be wider than the width of each gate line 11f.

The counter substrate 30f can be produced through the counter substrate production step of Embodiment 1 except that an aluminum film, for example, is deposited by a sputtering method and patterned by photolithography so as to form the black matrix 21f, instead of forming the black matrix 21a by, for example, applying a positive-type photosensitive resin with black pigment dispersed therein, while omitting the formation of the transparent layer 23.

Since the surface of the gate lines 11f of the liquid crystal display panel 50f of the present embodiment has the raised/recessed portion C formed in a raised/recessed shape, even if light of the backlight entering from the side of the active matrix substrate 20f is reflected by the surface of the black matrix 21f to be incident upon the surface of the gate line 11f, it is scattered by the surface of the raised/recessed portion C of the gate line 11f. Thus, since light of the backlight entering from the side of the active matrix substrate 20f of the liquid crystal display panel 50f is scattered by the raised/recessed portion C of the surface of the gate line 11f, it is possible to reduce the occurrence of light leakage from the liquid crystal display panel 50f. Therefore, with the transmissive liquid crystal display panel 50f, it is possible to reduce the occurrence of light leakage and to reduce the decrease in display quality.

### Embodiment 7

FIG. 9 is a cross-sectional view showing a liquid crystal display panel 50g of the present embodiment.

While the transmissive liquid crystal display panel 50e of Embodiment 5 includes the raised/recessed portion C provided on the surface of the black matrix 21e, and the transmissive liquid crystal display panel 50f of Embodiment 6 includes the raised/recessed portion C provided on the surface of the gate lines 11f, the transmissive liquid crystal display panel 50g of the present embodiment includes the raised/recessed portion C provided both on the surface of the black matrix 21e and on the surface of the gate lines 11f.

As shown in FIG. 9, the liquid crystal display panel 50g includes: the active matrix substrate 20f of Embodiment 6; the counter substrate 30e of Embodiment 5 placed opposing the active matrix substrate 20f; the liquid crystal layer 40 provided between the active matrix substrate 20f and the counter substrate 30e; and a sealing material (not shown) provided in a frame pattern for bonding the active matrix substrate 20f and the counter substrate 30e with each other and sealing the liquid crystal layer 40 between the active matrix substrate 20f and the counter substrate 30e. Here, the black matrix 21e of the counter substrate 30e includes a reflective film on the surface of the raised/recessed portion C, and is configured so as to scatter light from the backlight by the reflective film.

Since the surfaces of both the black matrix 21e and the gate lines 11f of the liquid crystal display panel 50g of the present embodiment have the raised/recessed portion C formed in a raised/recessed shape, even if light of the backlight entering from the side of the active matrix substrate 20f is incident upon the surface of the black matrix 21e, it is scattered by the surface of the raised/recessed portion C of the black matrix 21e. Even if a portion of the scattered light is incident upon the surface of the gate line 11f, it is scattered by the surface of the raised/recessed portion C of the gate line 11f. Thus, since light of the backlight entering from the side of the active matrix substrate 20f of the liquid crystal display panel 50g is scattered by the raised/recessed portion C of the surface of the black matrix 21e and the raised/recessed portion C of the surface of the gate lines 11f, it is possible to reduce the occurrence of light leakage from the liquid crystal display panel 50f. Therefore, with the transmissive liquid crystal display panel 50g, it is possible to reduce the occurrence of light leakage and to reduce the decrease in display quality.

While the embodiments above employ semi-transmissive and transmissive liquid crystal display panels, the present invention is also applicable to reflective liquid crystal display panels.

While the embodiments above use gate lines as light-reflecting lines, the present invention may also use source lines.

### INDUSTRIAL APPLICABILITY

As described above, since the present invention can reduce light leakage and reduce the decrease in display quality, the present invention is useful for transmissive, semi-transmissive and reflective liquid crystal display panels in general.

### DESCRIPTION OF REFERENCE CHARACTERS

C Raised/recessed portion
R Reflective region
T Transmissive region
11, 11c, 11f Gate line (line)
15e Interlayer insulating film
16 Second interlayer insulating film
17 Transparent electrode
18 Reflective electrode
19, 19e Pixel electrode
20a, 20c, 20e, 20f Active matrix substrate
21a, 21b, 21d, 21e, 21f Black matrix
21bb Reflective film
22 Colored layer
30a, 30b, 30d, 30e, 30f Counter substrate
40 Liquid crystal layer
50a-50g Liquid crystal display panel

1. A liquid crystal display panel comprising:
an active matrix substrate including a plurality of light-reflecting lines provided so as to extend parallel to each other, an insulating film provided so as to cover the lines, and a plurality of pixel electrodes provided in a matrix pattern on the insulating film;
a counter substrate placed opposing the active matrix substrate, and including a plurality of colored layers provided in a matrix pattern so as to respectively overlap the pixel electrodes, and a black matrix provided between the colored layers; and
a liquid crystal layer provided between the active matrix substrate and the counter substrate,
wherein at least one of the black matrix and the lines has a raised/recessed portion whose surface is formed in a raised/recessed shape.

2. The liquid crystal display panel of claim 1, wherein
the raised/recessed portion includes a reflective film on the surface thereof for scattering light incident upon the surface.

3. The liquid crystal display panel of claim 1, wherein
the raised/recessed portion has a light-absorbing property for absorbing light incident upon the surface thereof.

4. The liquid crystal display panel of claim 1, wherein
a raised portion of the raised/recessed portion is formed in a hemispherical shape.

5. The liquid crystal display panel of claim 1, wherein
the pixel electrodes each have a reflective electrode.

6. The liquid crystal display panel of claim 5, wherein
the insulating film is made of a resin.

7. The liquid crystal display panel of claim 5, wherein
the pixel electrodes each include a reflective region defined by the reflective electrode, and a transmissive region other than the reflective region.
